(19) United States
(12) Patent Application Publication
(10) Pub. No.: US 2004/0027118 A1
(43) Pub. Date: Feb. 12, 2004

(54) Proximity sensor circuit with programmable logic device controller

(76) Inventors: James Lenz, Brooklyn Park, MN (US); Nick Demma, Minneapolis, MN (US); Al Hrovat, Lino Lakes, MN (US)

Correspondence Address: HONEYWELL INTERNATIONAL INC., 101 COLUMBIA ROAD, P O BOX 2245, MORRISTOWN, NJ, 07962-2245, US

(21) Appl. No.: 10/217,664

(22) Filed: Aug. 12, 2002

(51) Int. Cl. G01B 7/00; G01B 7/14

(52) U.S. Cl. 324/207.26; 324/207.16

(57) ABSTRACT

An improved proximity sensing circuit and method is provided. In particular, the proximity sensing system includes an improved controller comprising a programmable logic device (“PLD”). In one particular aspect of the invention, the controller includes a field programmable gate array (“FPGA”) controller. In general, the proximity sensing system measures the AC and DC resistances of a proximity sensor and a precision resistor and, from these measured values, calculates a compensated resistance. The compensated resistance may be used to determine the gap. The measured AC and DC resistances of the proximity sensor may be used to perform a self diagnostic on the sensing system and aid in determining a system fault.

### FIELD OF INVENTION

The present invention is generally related to proximity sensor circuits. In particular, the invention relates to proximity sensor circuits having a programmable logic device controller and methods associated with the same.

### BACKGROUND OF THE INVENTION

Proximity sensors are generally well known. Examples of proximity sensing circuits are described in U.S. Pat. Nos. 6,014,022 and 6,025,711, issued to Demma et al. on Jan. 11, 2000 and Feb. 15, 2000, respectively. These patents disclose a proximity sensing circuit having a plurality of sensors and precision resistors (i.e., test resistors) connected in signal communication with a multiplexer. The number of system components is minimized by using a single filter system connected between the multiplexer and a microcontroller or microprocessor, for the multiple sensors of the system. Readings from the precision resistors allow the system to diagnose the operation of the sensing circuit, determine if the system is malfunctioning, and calculate a perceived error so corrective action may be taken. The proximity sensing circuit measures and analyzes the AC resistance (or impedance) and DC resistance of the sensors and precision resistors and, from these measured values, determines a compensated resistance. The compensated resistance is used to determine the distance between the proximity sensor and a target ( i.e., “gap”). Additionally, the measured AC and DC resistances of the proximity sensor are used to perform the self diagnostic on the sensing system and aid in determining a system fault, as well as various other tasks as described in the '022 and '711 patents.

Another proximity sensing circuit is described in U.S. Pat. No. 5,180,978 issued to Postma et al. on Jan. 19, 1993. This patent discloses a sensor with a reduced temperature sensitivity that directly measures the parameters of a proximity sensor coil to determine both the AC and DC resistances of the coil. Alternatively, the real and/or imaginary AC components of the impedance may be measured. These parameters are then used to determine a discriminator value magnitude according to a mathematical relationship that has been predetermined through previous analysis of empirical data for the particular coil and application intended for the sensor.

The proximity sensing circuit of the '022 and '711 patents improves upon the '978 sensing circuit, for example, by reducing the number of system components, by decreasing the effects from electromagnetic interference (EMI), and by performing a self diagnostic test to determine if the system components were working together properly. Notwithstanding these advantages, drawbacks of these proximity sensors and similar proximity sensing circuits remain. One such problem is the use of a microprocessor for the digital signal processing. Microprocessors may provide a low cost solution in high volume production, but for many applications mass production of a software-based processing system is not the objective. Rather, individual programming or on-site programming and the ability to modify the programming may be desirable. In addition, the performance of the microprocessor can fall short of expectations due to slow processing times and unexpected software “glitches.”

Accordingly, a need exists for an improved proximity sensing circuit and method for the same that overcomes the problems of currently available proximity sensing systems. In particular, a proximity sensing circuit that maintains the advantages addressed by the '022 and '711 circuit and that provides improved performance.

### SUMMARY OF THE INVENTION

The invention, in general, addresses these and other needs by providing a proximity sensing system and method having a programmable logic device (PLD) controller. The PLD controller configured to generate a control signal received at one or more sensing devices. A response signal is suitably received at the PLD controller from the sensing device. The PLD controller generates an output signal as a function of the response signal.

In one particular embodiment, a proximity sensing system and method includes a field programmable gate array (FPGA) controller.

### BRIEF DESCRIPTION OF THE DRAWINGS

These and other features, aspects and advantages of the present invention will become better understood with reference to the following description, appending claims, and accompanying drawings where:

FIGS. 1 and 4 illustrate, in block format, exemplary proximity sensing systems in accordance with various embodiments of the invention;

FIG. 2 illustrates an exemplary waveform for use in a proximity sensing system of the invention;

FIG. 3 is a hypothetical matrix for use by the invention to diagnose certain system conditions and was originally disclosed as FIG. 9 of U.S. Pat. Nos. 6,014,022 and 6,025,711, issued to Demma et al. on Jan. 11, 2000 and Feb. 15, 2000, respectively;

FIGS. 5a and 5b illustrate circuit schematics of a driver-filter device in accordance with an exemplary embodiment of the invention; and

FIG. 6 illustrates a circuit schematic of a field programmable gate array (FPGA) embodiment of an exemplary proximity sensing system.

### DETAILED DESCRIPTION

Various embodiments of the invention relate to proximity sensor circuits and for associated methods and, more particularly, to proximity sensing circuit systems and methods having programmable logic device controllers. In general, the system and method for proximity sensing measures the AC and DC resistances of a proximity sensor and a precision resistor and, from these measured values, calculates a compensated resistance. The compensated resistance may be used to determine the distance between the proximity sensor and a target (“gap”). Moreover, the measured AC and DC resistances of the proximity sensor may be used to perform a self diagnostic on the sensing system and to aid in determining a system fault. The present invention provides an improved controller over the prior art proximity sensors, such as the proximity sensor circuits and systems disclosed in U.S. Pat. Nos. 6,014,022 and 6,025,711, issued to Demma et al. on Jan. 11, 2000 and Feb. 15, 2000, respectively, the entire disclosures of which are hereby incorporated by reference.

The invention is particularly suited for use in connection with complex mechanical and electrical systems, such as aircraft and avionics systems. As a result, the exemplary embodiments of the present invention are described in that context. It should be recognized, however, that such description is not intended as a limitation on the use or applicability of the present invention; but instead is provided as illustrative of various embodiments of the invention, including its best mode.

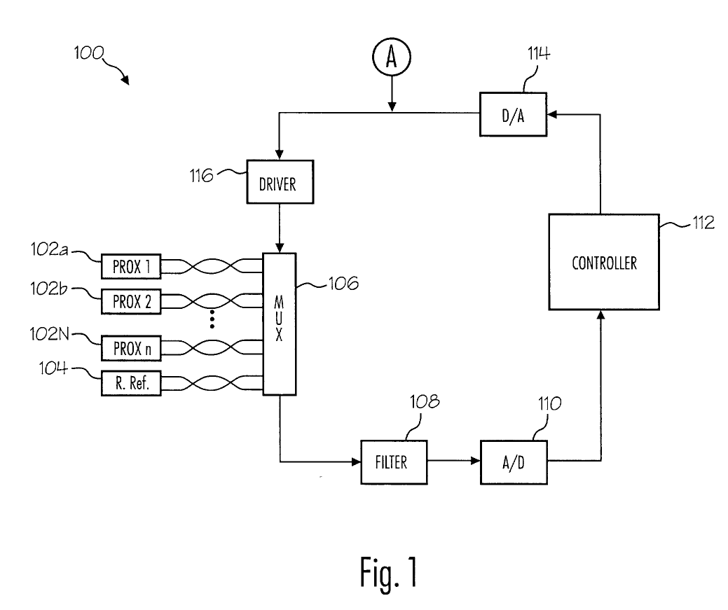

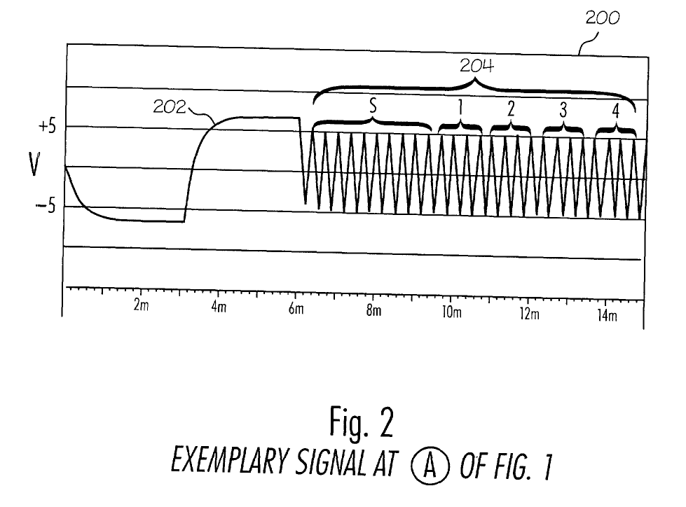

FIG. 1 illustrates, in block format, a proximity sensing system 100 of the invention. System 100 generally includes at least one proximity sensor 102a-102n, a precision resistor 104, a multiplexer 106, a filter 108, an analog to digital converter (A/D) 110, a controller 112, a digital to analog converter (D/A) 114, and a driver 116. Proximity sensor 102 may include any suitable proximity sensing device generally known or discovered. In general, proximity sensors have an internal coil (not shown in FIG. 1) which is mounted near a face surface of a sensor housing. The coil is connected to the output of a driver for the purpose of providing a relatively high frequency current through the coil winding. In one particular embodiment, a commercial aircraft may include numerous proximity sensors, e.g., proximity sensors 102a-102n, each coupled to multiplexer 106 by wiring, cables or the like, and preferably, with a two wire configuration for transmitting and receiving signals from proximity sensor 102 to multiplexer 106. The multiple sensors in an aircraft application may be located throughout the body of the aircraft and the remaining elements of system 100 may be housed in an avionics box located in the aircraft's avionics bay.

Precision resistor 104 comprises a “test” resistor and may be used by system 100 to perform a self diagnostic. If the measured value of the precision resistor differs significantly from the known value of the precision resistor, an alarm can be generated to indicate a malfunction has occurred. Alternatively, minor differences between the measured value of a precision resistor and its actual known value can be responded to by the application of a correction factor by controller 112. Additionally, because the value of precision resistor 104 is fixed, any deviation in the measured values of precision resistor 104 can be used to determine certain characteristics of system 100, e.g., temperature effects, circuit offset, and gain. The value of precision resistor 104 may be configured to be approximately equal to the midrange of the value of resistance of proximity sensor 102. Although not required, precision resistor 104 may be conveniently located within multiplexer 106. While only a single precision resistor 104 is shown, additional precision resistors may be included depending upon the particular application.

Multiplexer 106 receives commands from controller 112 which instruct multiplexer 106 to transmit and receive signals from proximity sensor 102 and/or precision resistor 104. In order to reduce the number of components in a system, multiplexers may be used to permit a single device, such as a controller 112, to receive signals from a plurality of components, such as sensors 102. Signals from each proximity sensor 102 and precision resistor 104 are passed through multiplexer 106 to filter 108. In this way, a single filter network can be used to filter the signals from each of the individual sensors.

After filtering, the signals are provided to A/D 110 for conversion to a digital waveform. Controller 112 receives a digitized signal representative of the filtered signal received from each proximity sensor 102 and/or precision resistor 104. Controller 112 may include one or more counters to assist the controller in tracking which proximity sensor 102 the received signal is from. Controller 112 may include any suitable processing system including, but not limited to, a microprocessor, microcontroller, digital signal processor, 32-bit processor, 16-bit processor, programmable logic device, or other integrated circuitry. In some applications, controller 112 may further include one or more programmable algorithms, software applications, or the like, for computing various values which may be used to self calibrate system 100, detect gap, and determine system faults. Software instructions may be stored in any type of digital storage medium such as RAM, ROM, or other memory in communication with controller 112.

The outputs of controller 112, e.g., commands to multiplexer 106, are generally in digital form and therefore are converted to analog representations by D/A 114.

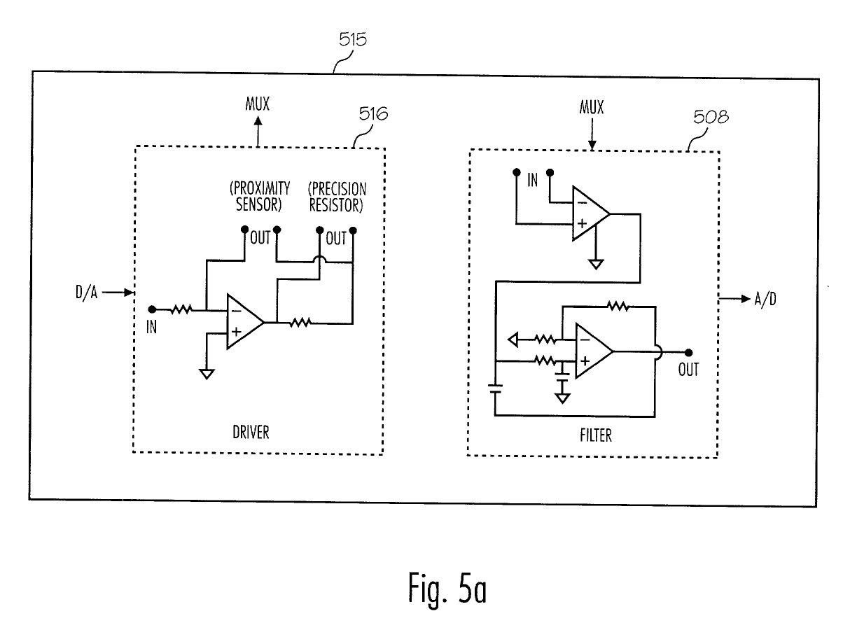

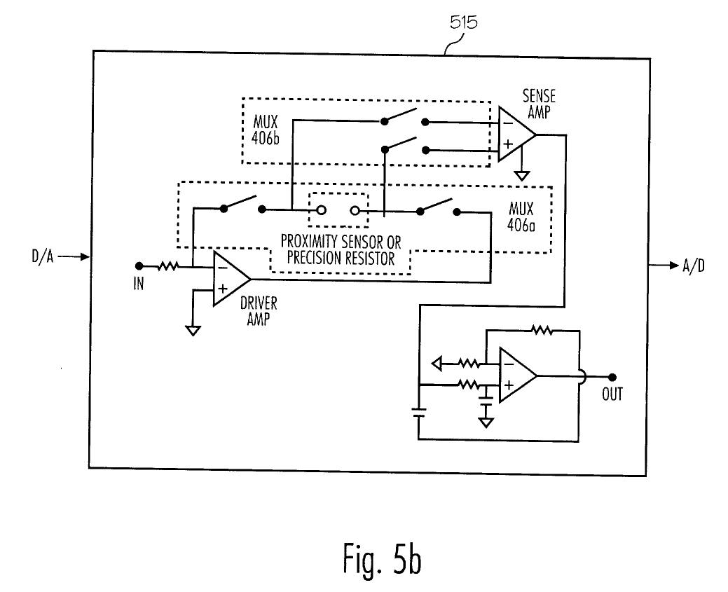

With combined reference to FIGS. 1 and 2, a predetermined voltage signal or other waveform may be transmitted to each proximity sensor 102, such as exemplary waveform 200. In this manner, a control signal is sent to proximity sensor 102 so that the returned distorted signal can be analyzed for deviances. Controller 112 may generate the control signal. For example, a controlled DC portion 202 and an AC portion 204 of waveform 200 may be periodically generated. AC portion 204 may include a short stabilization section (denoted as “S” on FIG. 2) to stabilize the post DC waveform. Additionally, AC portion 204 includes a section for each proximity sensor 102 and precision resistor 104 (denoted as numerals “1-4” on FIG. 2). The waveform is generally received by driver 116, for example as indicated by the letter “A” on FIG. 1, which suitably amplifies the current to enable detection by multiplexer 106. In addition, driver 116 may be configured to compensate for imperfections in system 100. As discussed in detail below, FIG. 5 illustrates an exemplary driver and filter circuit in accordance with the invention.

As previously discussed, periodic measurements are received at controller 112 from each proximity sensor 102 and precision resistor 104 which are used to, among other things, compute a compensated resistance. For example, as described in detail in U.S. Pat. No. 5,180,978 issued to Postma et al. on Jan. 19, 1993, the entire disclosure of which is hereby incorporated by reference, the proximity sensor measures the AC impedance and DC resistance and combines these two values to form a synthesized magnitude which is referred to as the compensated resistance. The compensated resistance, R_{c}, can be used to determine the actual gap between a metallic object and the coil of the proximity sensor. The relationship between R_{c} and the gap is typically nonlinear and thus R_{c} may be compared to various threshold magnitudes to make the determination of whether or not a metallic object is within a detection zone proximate the coil. These techniques and further details are described in the '022 and '711 patents, previously incorporated by reference.

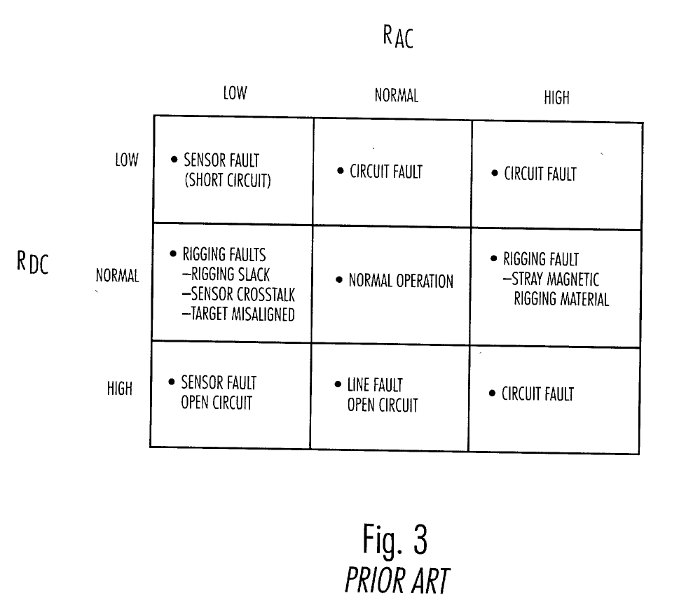

Prior to the combination of the AC impedance and DC resistance of the proximity sensor and/or precision resistor, the two raw values of the AC impedance (R_{AC}) and DC resistance (R_{DC}) can be used in cooperation with each other to define certain types of system conditions. FIG. 3 is a reproduction of a hypothetical matrix from the '711 and '022 patents that could be used for these purposes. As fully described in the '711 and '022 patents, the matrix can help identify various probable system conditions based on the R_{AC} and R_{DC} values. In addition to performing analysis on the impedances, it should be appreciated that the inductance of the sensors may also be used in a similar manner to define system conditions. As further described in the '711 and '022 patents, the mathematical combinations are analyzed by a microcontroller or microprocessor and it is the microprocessor that calculates R_{C} and identifies the various system conditions. While microprocessors have performed well in the past for digital signal processing, and in particular for the applications described in the '711, '022 and '978 patents, there are drawbacks associated with the use of microprocessors in some applications that will be addressed below.

In one embodiment, controller 112 includes a programmable logic integrated circuit or programmable logic device (PLD) such as, e.g., a conventional discrete fixed logic, a PROM based programmable logic, a simple programmable logic device (SPLD), a complex programmable logic device (CPLD), a mask programmable gate array (MPGA), and a field programmable gate array (FPGA). PLDs are general-purpose combinational or sequential digital components whose ultimate function is determined by the designer as opposed to the manufacturer of the device. In other words, PLDs generally leave the manufacturer in an unprogrammed state. One advantage to using a hardwired component, such as the PLD, is the avoidance of installing and executing software on a processor, and design revisions, even for a fielded product, can be implemented quickly. In addition, system hardware can generally be reduced, for example, as compared to a microprocessor system, by taking advantage of the PLDs reconfigurability. In general, logic components stabilize faster than, for example, microprocessors, from a “cold start” condition. Moreover, data update rates for PLDs are generally faster than with traditional processing systems.

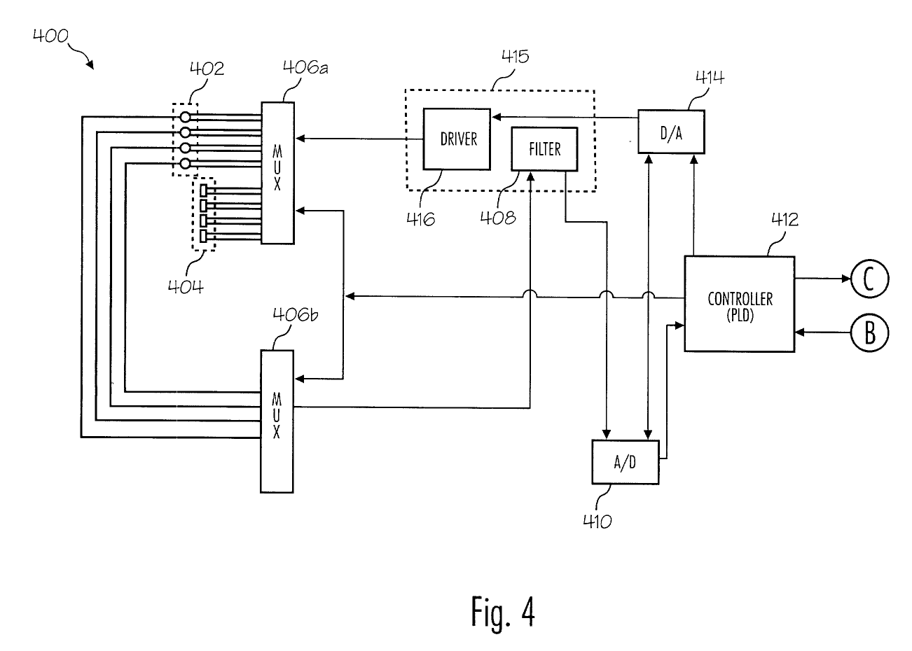

FIG. 4 illustrates, in block format, another embodiment of a proximity sensing system 400 in accordance with the invention. Similar to proximity sensing system 100, system 400 generally includes at least one proximity sensor, represented by dashed box 402, at least one precision resistor, represented by dashed box 404, two multiplexers 406A and 406B, a filter 408, an A/D converter 410, a controller 412, a D/A converter 414, and a driver 416. In this particular embodiment, controller 412 includes a programmable logic device or PLD as previously described. PLD 412 may receive commands from various other systems in communication with proximity sensing system 400, illustrated as letter “B” on FIG. 4. For example, a command to check a particular sensor 402 may be received at PLD 412 that causes PLD 412 to provide a command to multiplexer 406. Multiplexer 406 then connects to the specific proximity sensor of 402 and data can be retrieved, e.g., to calculate the gap. In a similar manner, information may be transmitted from system 400, illustrated as letter “C” on FIG. 4, back to a requesting system or some other system in communication with proximity sensing system 400.

In FIG. 4, four precision resistors 404 are illustrated, but different configurations and implementations may use any number of precision resistors, including a single precision resistor. To perform a self diagnosis, PLD 412 periodically causes multiplexer 406 to switch to one of the precision resistors. If the measured value of the precision resistor differs significantly from the known value of the precision resistor, an alarm can be generated, a corrector factor may be applied, or some other response as determined by the system operator may be made.

Driver 416 and filter 408 are shown in FIG. 4 as functionally separated; alternatively, however, a single commercially available device, represented by dashed line 415, may be used to accomplish the multiple tasks. FIGS. 5a and 5b illustrate circuit schematics of an exemplary driver-filter device 515 for use in a proximity sensing system of the invention.

Device 515 may include one or more individual components, such as operational amplifiers (“op amps”), that may be interconnected to perform various tasks. In the particular embodiment shown, a driver portion 516 and a filter portion 508 are illustrated. Driver 516 includes an amplification device, such as an op amp, configured to receive a signal, e.g., from D/A 414, and suitably amplify the signal for easier detection, e.g., by multiplexer 406. The signal received by driver 516 may be similar to the waveform illustrated in FIG. 2. The proximity sensor is in the feedback loop to the op amp driver and in this configuration, a high impedance driver results that is not disturbed by impedance variations from the proximity sensor, and assists in compensating for imperfections in the overall analog electrical components of device 515.

The output of driver 516 may be intended for a particular proximity sensor or a precision resistor, as shown on FIGS. 5a and 5b. Driver circuit 516 is connected to the proximity sensor through the multiplexer and its analog switches (shown on FIG. 5b). For example, FIG. 5b illustrates the interaction between the driver and the filter via the multiplexers. A separate multiplexer of analog switches is used as a sense to the impedance and input to the instrumentation or sense amplifier of filter 508 (i.e., the input amplifier of filter 508). Another characteristic of this particular driver configuration is that the reference resistor or precision resistor is connected to act as a passive reference element.

Exemplary filter 508 includes two op amps that act as an impedance match and a frequency filter for input of a waveform (e.g., waveform 200) to the A/D converter. As previously mentioned, the signal output of the multiplexer is received by a single filter, such as filter 508. The filtered signal is then output to the A/D, as indicated on FIG. 5. It should be appreciated that the driver-filter schematic of FIG. 5 is provided as an example of a contemplated device and is not intended to be limited.

In another embodiment of the invention, controller 112, 412 includes a particular PLD known as a “field programmable gate array” or FPGA. Field programmable, as the name indicates, generally means that the FPGA's function is defined by a user's program rather than by the manufacturer of the device. Depending on the particular application, the program is typically either “burned” into the device permanently or semi-permanently as part of a board assembly process, or may be loaded from an external memory each time the system is powered up. End-user programmability gives the user access to complex integrated designs without the high engineering costs typically associated with application-specific integrated circuits. The ability to manipulate the logic at the gate level allows the user to construct a custom processor to efficiently implement the desired functions. By near-simultaneously performing all the algorithms subfunctions, the FPGA can typically outperform a conventional digital signal processor (DSP) and is generally more than twice as fast. The programmable logic in the FPGA can absorb much of the interface and glue-logic associated with traditional microprocessors. The tighter integration of the FPGA can result in a smaller overall product design, lighter in weight, lower cost and even lower power consumption over a traditional microprocessor DSP.

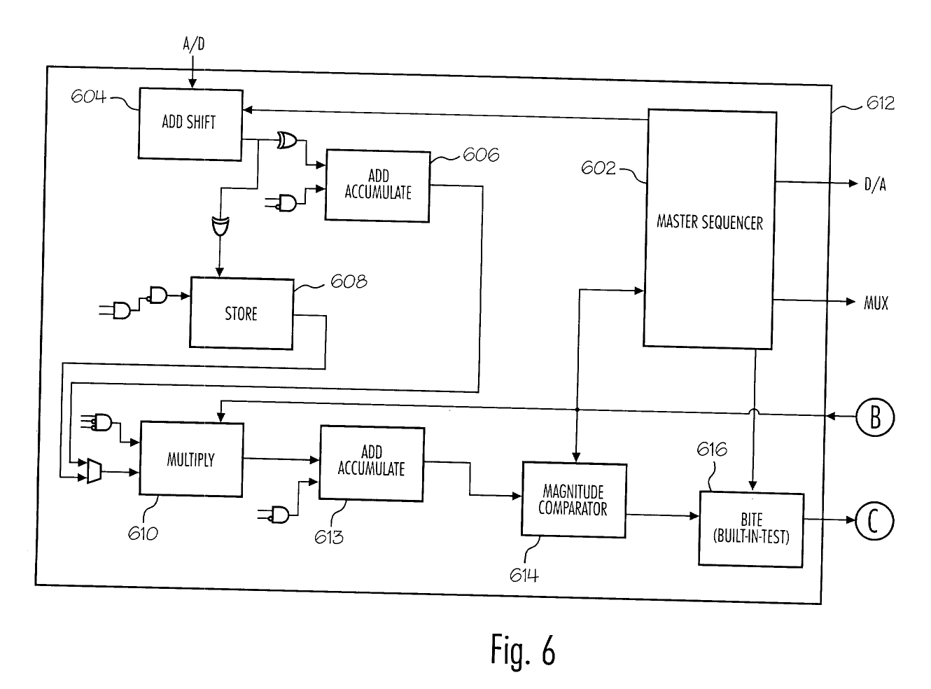

FIG. 6 illustrates a circuit schematic of an exemplary field programmable gate array (FPGA) controller 612 for use in a proximity sensing circuit in accordance with the principles of the invention. FPGA controller 612 includes various logic components that may be programmed by the end user to perform a desired function(s). For example, FPGA controller 612 generally includes a master sequencer 602, add shift 604, add accumulate 606 and 613, store 608, multiply 610, magnitude comparator 614, and BITE or “built-in-test” 616. It should be appreciated and recognized that FPGA controller 612 may include various other logic components and gates that are not shown to simplify the schematic. It should also be appreciated that the particular embodiment shown in FIG. 6 is only one example of the connections and/or logics capable of performing the functions desired by the present invention and numerous other configurations may equally perform the intended functions. BITE 616 suitably transmits the status, as determined by the combination of components of FPGA controller 612, of a “tested” resistor or precision resistor, as indicated by output “C”. This built-in-test function may be similar to the previously described self-diagnostic test, or this function may represent a requested status for a precision resistor or sensor. Similar to the input “B” and output “C” of FIG. 4, “B” on FIG. 6 may indicate a system command to the controller. The various other inputs and outputs (or interfaces) to FPGA controller 612 were previously described for system 400 and will not repeated herein.

It should be appreciated that the particular implementations shown and described herein are illustrative of various embodiments of the invention including its best mode, and are not intended to limit the scope of the present invention in any way. For the sake of brevity, conventional techniques for signal processing, data transmission, signaling, and network control, and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical sensing system.

1. A proximity sensing system comprising:
a plurality of sensors;
a multiplexer in signal communication with each of said sensors; and
a programmable logic device (PLD) controller operatively coupled to said multiplexer and configured to generate a control signal directed to one or more of said sensors, wherein said PLD controller receives a response signal from said one or more sensors and generates an output signal as a function of said response signal.

2. The proximity sensing system of claim 1, wherein said PLD controller comprises a field programmable gate array (FPGA).

3. The proximity sensing system of claim 1, further comprising a precision resistor in signal communication with said multiplexer.

4. The proximity sensing system of claim 3, wherein said PLD controller receives a response signal from said precision resistor and generates said output signal as a function of said response signal.

5. The proximity sensing system of claim 1, wherein said output signal comprises a distance between one or more of said sensors and a reference object.

6. The proximity sensing system of claim 1, wherein said output signal comprises a diagnosis of the operation of said system.

7. The proximity sensing system of claim 1, wherein said control signal comprises an AC portion and a DC portion.

8. A proximity sensing system comprising:
an analog portion comprising a proximity sensor and a precision resistor, said analog portion configured to receive a waveform and provide an analog response thereto from at least one of said proximity sensor or said precision resistor;
an analog-to-digital converter configured to receive said analog response and provide a digital representation thereof;
a digital-to-analog converter configured to receive said waveform in digital form and provide an analog representation thereof to said analog portion; and
a digital portion comprising a programmable logic device configured to generate said waveform, analyze said digital representation and provide an output signal as a function of said digital representation.

9. The proximity sensing system of claim 8, wherein said waveform comprises an AC portion and a DC portion.

10. The proximity sensing system of claim 8, wherein said digital portion comprises a programmable gate array.

11. The proximity sensing system of claim 8, wherein said analog portion comprises a driver having an amplifier and said sensor and said resistor being coupled to a feedback loop of said amplifier.

12. The proximity sensing system of claim 11, wherein said driver provides high impedance.

13. The proximity sensing system of claim 8, wherein said analog portion comprises a filter configured for impedance matching and frequency filtering for said waveform.

14. A proximity sensing system comprising:
a plurality of sensors;
a multiplexer in signal communication with each of said sensors;
a driver having an amplification device configured to receive a control signal directed to one or more of said sensors, said sensors coupled to a feedback loop of said amplification device via said multiplexer;
a filter in signal communication with said multiplexer and configured for impedance matching and frequency filtering of said control signal; and
a programmable logic device controller operatively coupled to said multiplexer and configured to generate said control signal, wherein said PLD controller receives a response signal from said one or more sensors and generates an output signal as a function of said response signal.

15. The proximity sensing system of claim 14, wherein said driver provides high impedance.

16. The proximity sensing system of claim 14, wherein said controller comprises a field programmable gate array.

17. The proximity sensing system of claim 14, wherein said output signal comprises a distance between said sensor and a reference object.

18. The proximity sensing system of claim 14, wherein said output signal comprises a diagnosis of the operation of said system.

19. The proximity sensing system of claim 14, wherein said control signal comprises an AC portion and a DC portion.

20. A method of proximity sensing comprising:
generating, at a programmable logic device (PLD) controller, a control waveform;
providing said waveform to a sensing device;
receiving, at said PLD controller, a response from said sensing device;
analyzing, at said PLD controller, said response; and
causing an output as a function of said response.

21. The method of claim 20 further comprising:
amplifying said waveform; and
providing said waveform to said sensing device via a multiplexer coupled to a feedback loop of an amplification device.

22. The method of claim 20, wherein said generating a control waveform comprises generating an AC portion and a DC portion.

23. The method of claim 20, wherein said providing comprises converting said waveform from digital to analog.

24. The method of claim 20, wherein said sensing device comprises a test component and said output comprises a diagnosis of the operation of said component.

25. The method of claim 20, wherein said PLD controller comprises a field programmable gate array.

26. The method of claim 20, wherein said output comprises a distance between said sensing device and a reference object.

27. The method of claim 26, wherein said response comprises an AC impedance and a DC resistance of said sensing device.

28. The method of claim 27, wherein said analyzing comprises combining said AC impedance and said DC resistance to determine a compensated value.
